(19) United States
(12) Patent Application Publication
(10) Pub. No.: US 2019/0101426 A1
(43) Pub. Date: Apr. 4, 2019

(54) MAINTAINING REDUNDANT DATA ON A GAS METER

(71) Applicant: Dresser, LLC, Houston, TX (US)

(72) Inventors: Roman Leon Artiuch, Houston, TX (US); Francisco Manuel Gutierrez, League City, TX (US); Francisco Enrique Jimenez, Spring, TX (US); Jeff Thomas Martin, Spring, TX (US)

(21) Appl. No.: 16/147,785

(22) Filed: Sep. 30, 2018

Related U.S. Application Data
(63) Continuation-in-part of application No. 15/356,594, filed on Nov. 20, 2016.
Application No. 15/356,594 is a continuation-in-part of application No. 14/301,986, filed on Jun. 11, 2014, now Pat. No. 9,874,468.
(60) Provisional application No. 61/835,497, filed on Jun. 14, 2013.

(51) Int. Cl. G01F 15/06; G01F 1/075

(52) U.S. Cl. CPC G01F 15/068; G01F 1/0755

(57) ABSTRACT

An encoder device that is configured for use on a gas utility meter. These configurations may generate power and data concomitantly with movement of mechanics in response to flow of material through the meter. In one implementation, the meter may include a meter body with flanged ends, the meter body forming an interior cavity. Impellers may reside in the interior cavity to meter precise volume of fuel gas through the device. The encoder device may couple with the impellers, for example, using non-contact modalities, like magnetics. The encoder device may include a processor and memory, a sensor unit, and a power unit, where the sensor unit and the power unit are responsive to rotation of the impellers to generate a data signal and a power signal, respectively, without contact with the impellers.

### CROSS-REFERENCE TO RELATED APPLICATIONS

This application is a continuation-in-part of U.S. patent application Ser. No. 15/356,594, filed on Nov. 20, 2016, and entitled “MODULAR METERING SYSTEM,” which is a continuation-in-part U.S. patent application Ser. No. 14/301,986, filed on Jun. 11, 2014, and entitled “SYSTEMS, DEVICES, AND METHODS FOR MEASURING AND PROCESSING FUEL METER MEASUREMENTS,” now U.S. Pat. No. 9,874,468, which claims the benefit of U.S. Provisional Application Ser. No. 61/835,497, filed on Jun. 14, 2013, and entitled “DIGITAL METER BODY MODULE FOR ROTARY GAS METER.” The content of these applications is incorporated herein in its entirety.

### BACKGROUND

Utility companies deliver a wide range of resources to customers. These resources include fuel gas for heat, hot water, and cooking. It is normal for the utility to install its own equipment on site to measure consumption of the fuel gas. This equipment often includes a gas meter to measure or “meter” an amount of fuel gas the customer uses (so the utility can provide an accurate bill). Likely, the gas meter is subject to certain “legal metrology” standards that regulatory bodies promulgate under authority or legal framework of a given country or territory. These standards are in place to ensure the gas meter provides accurate and repeatable data, essentially to protect consumers from inappropriate billing practices. In the past, gas meters made use of mechanical “counters” to meter consumption of fuel gas. These mechanisms could leverage flow of the fuel gas into an essentially immutable measure of consumption. Advances in technology allow for electronics to replace these mechanisms. These electronics can provide even more accurate data, both for billing and for use in diagnostics of device health and the like. But, despite these benefits, failures in the electronics or disruptions to power necessary for these devices to operate may result in loss of data that frustrates accurate measures of consumption and, consequently, may lead to unnecessary disputes with customers and lost revenue.

### SUMMARY

The subject matter of this disclosure relates to improvements to ensure that metrology hardware may continue to record data in lieu of power on the device. Of particular interest herein are embodiments that can concomitantly generate data and energy from mechanical movement on the device. This mechanical movement may correspond with mechanisms, like counter-rotating impellers, that leverage positive displacement as means to measure precisely the volume of fuel gas.

### DRAWINGS

Reference is now made briefly to the accompanying figures, in which:

FIG. 1 depicts a schematic diagram of an exemplary embodiment of an encoder device;

FIG. 2 depicts a schematic diagram of an example of the encoder device of FIG. 1;

FIG. 3 depicts a schematic diagram of an example of the encoder device of FIG. 1;

FIG. 4 depicts a schematic diagram of memory for use in the device of FIG. 1;

FIG. 5 depicts a schematic diagram of an example of the encoder device of FIG. 1;

FIG. 6 depicts a perspective view of the encoder of FIG. 5 on an exemplary gas meter;

FIG. 7 depicts a perspective view of the gas meter of FIG. 6 in partially-exploded form;

FIG. 8 depicts a schematic diagram of exemplary structure for a power unit for use in the encoder device of FIG. 1; and

FIG. 9 depicts a perspective view of exemplary structure for the gas meter.

Where applicable like reference characters designate identical or corresponding components and units throughout the several views, which are not to scale unless otherwise indicated. The embodiments disclosed herein may include elements that appear in one or more of the several views or in combinations of the several views. Moreover, methods are exemplary only and may be modified by, for example, reordering, adding, removing, and/or altering the individual stages.

### DETAILED DESCRIPTION

This discussion describes embodiments with hardware to harvest energy. The embodiments may include devices that can meter flow of materials. These devices include gas meters, which this discussion uses to illustrate the concepts herein. The hardware integrates into the gas meter to maintain data that might otherwise be lost due to problems with power or electronics. Other embodiments are with the scope of this disclosure.

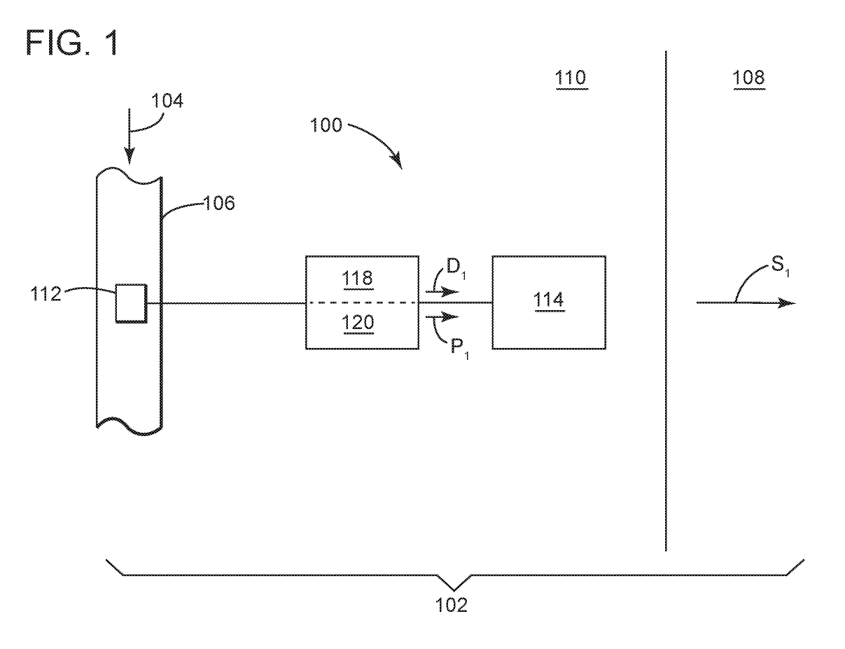

FIG. 1 depicts a schematic diagram of an exemplary embodiment of an encoder device 100. This embodiment is part of metrology hardware, identified generally by the numeral 102. The metrology hardware 102 may embody devices that quantify a value that defines flow parameters of resource 104, typically as it flows in a conduit 106. These devices may include an indexing unit 108 that couples with a metering unit 110 to exchange a digital signal S₁. The metering unit 110 may couple with the conduit 106 to locate a flow mechanism 112 in the flow of resource 104. As also shown, the encoder device 100 may include a data processing unit 114 with an interface unit 116 that couples with the flow mechanism 112. The interface unit 116 may include a sensor unit 118 and a power unit 120 that generate a data signal D₁ and power signal P₁, respectively.

Broadly, the encoder device 100 is configured to generate redundant data in lieu of power or other disruptions on the metrology hardware 102. These configurations can essentially “back-up” data that corresponds to precise volume of material that flows through the metrology hardware 102. This feature outfits the metrology hardware 102 to maintain consistent records of consumer consumption, even with power disruptions or outages that might normally foreclose activities by the metrology hardware 102 to collect and retain data of this type.

The metrology hardware 102 may be configured to measure or “meter” flow of material. These configurations often find use in residential and commercial locations to quantify demand for resource 104 at a customer. It is possible that metrology hardware 102 is found in custody transfer or like inventory management applications as well. For purposes of this discussion, resource 104 may be fuel gas (like natural gas); but the metrology hardware 102 may measure consumption of other solid, fluids (e.g., water), and solid-fluid mixes. The conduit 106 may embody pipes or pipelines. These pipes may form part of a distribution network that distributes fuel gas 104 to customers. The distribution network may employ intricate networks of piping that cover vast areas of towns or cities with hundreds or thousands customers. In most cases, utilities maintain responsibility for upkeep, maintenance, and repair of the gas meter 102. Notably, this disclosure contemplates use of more than one of encoder device 100 on the gas meter 102.

The units 108, 110 may be configured to cooperate to generate data that defines consumption of fuel gas 104. These configurations may embody standalone devices that connect with one another to exchange data or other information. Electronics on the indexing unit 108 may process the digital signal S₁. These electronics may reside inside a plastic or composite housing that attaches or secures to parts of the metering unit 110. These parts may be part of a cast or machined body, preferably metal or metal-alloy, which mates with the conduit 106 to receive fuel gas 104. This “meter” body may enclose flow mechanics 112, for example, mechanisms that move in response to flow of fuel gas 104 from inlet to outlet on the meter body. Exemplary mechanisms may embody counter-rotating impellers, diaphragms, or like devices with movement that can coincide with a precise volume of the fuel gas 104; but this disclosure contemplates others as well.

The data processing unit 114 may be configured to quantify flow parameters for fuel gas 104. These configurations may employ computing devices that process data to generate values, like volumetric flow, flow rate, velocity, energy, and the like. These processes may also account for (or “correct for”) conditions that prevail at the gas meter 102. These conditions may describe characteristics of fuel gas 104 or the environment, including ambient temperature, absolute pressure, differential pressure, and relative humidity, among others. The processes may use data for these characteristics to ensure accurate and reliable values for billing customers.

The interface unit 116 may be configured to generate data for use to determine volumetric flow. These configurations may include a device that can couple with impellers 112. This device may include hardware that “talks” with corresponding hardware that co-rotates with the impellers 112. This feature may leverage non-contact modalities or technology, like magnetics, ultrasonics, or piezoelectrics; however, this disclosure does contemplates technologies not yet developed as well. In one implementation, the metering unit 110 may include one or more magnets that co-rotate with the impellers 112. The rotation may change a magnetic field to simulate corresponding devices of the interface unit 116 to generate the signals D₁, P₁ noted herein.

The units 118, 120 may be configured to convert rotation of the impellers 112 into useable form. On the sensor unit 118, these configurations may include hardware that leverages the “Wiegand effect” to generate the data signal D₁, for example, as output voltage or “pulses” that track with each rotation of magnets that occurs concomitantly with rotation of the impellers 112. The power unit 120 may embody hardware that can generate energy in response to the co-rotating magnets as well. This hardware may embody a device with a thin wire conductor that wraps around a solid or hollow magnetic core, but other configurations may prevail as well. For both units 118, 120, this disclosure contemplates other types of devices known now or hereinafter developed.

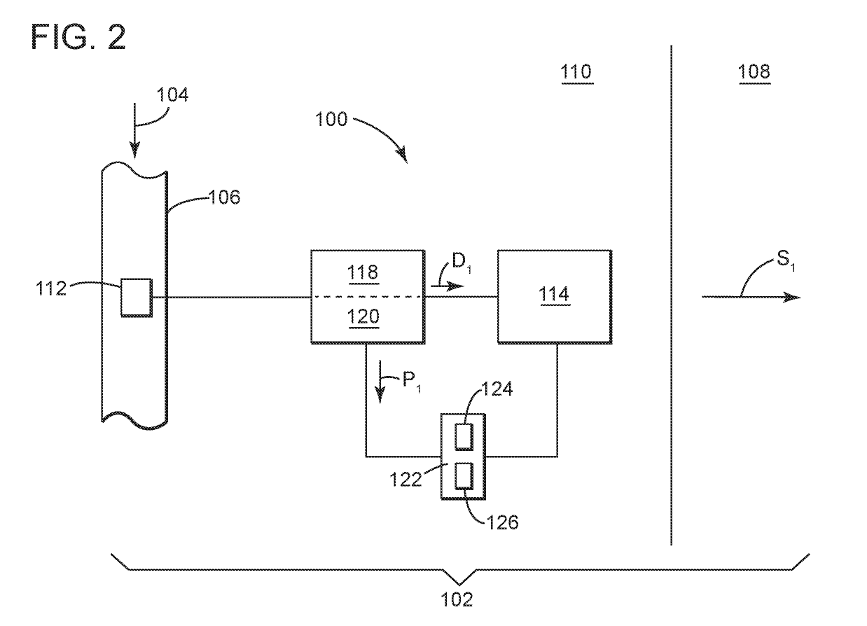

FIG. 2 depicts a schematic diagram of exemplary topology for the encoder device 100 of FIG. 1. The encoder device 100 may include a power management unit 122 that interposes between the data processing unit 114 and the power unit 120. The power management unit 122 may include a conditioning unit 124 and a storage unit 126. The conditioning unit 124 may include circuitry necessary to format the power signal S₁ for use on the device. This circuitry may include inverters, converters, rectifiers, amplifiers, and like devices that can operate on the power signal S₁ to make it more useful or consistent with other parts of the topology, including for use by the storage unit 126. Examples of the storage unit 126 may include devices that retain energy, like a battery. Other devices may include capacitors, particularly those with low leakage voltage and like parameters to retain and distribute power for extended periods of time.

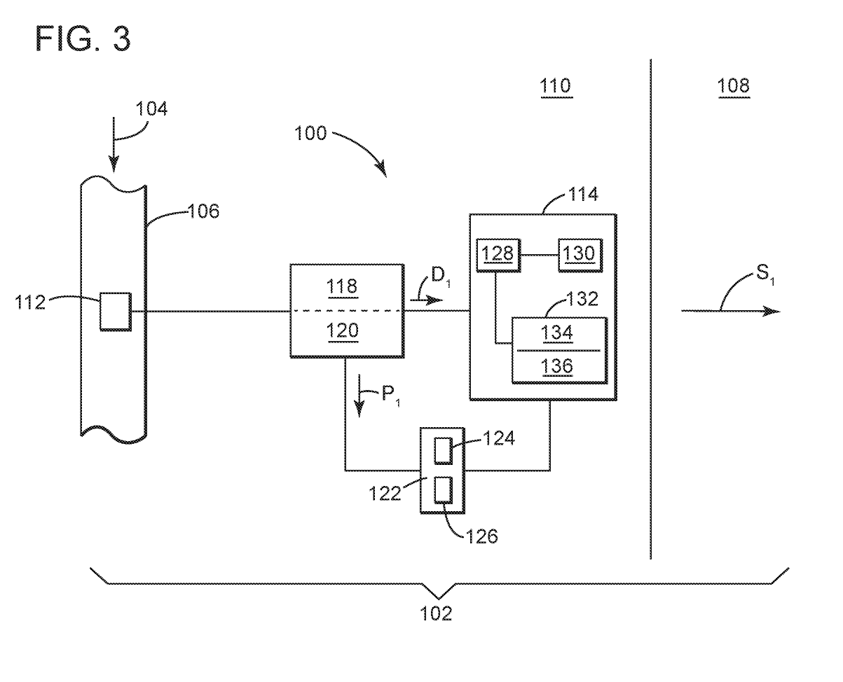

FIG. 3 depicts a schematic diagram of exemplary topology for the encoder device of FIG. 1. The data processing unit 114 may including computing components, like a processor 128 that couples with a timing circuit 130 and with memory 132. Data in the form of executable instructions 134 and resident data 136 may reside on memory 132. The components 128, 130, 132 may integrate together as a micro-controller or like integrated processing device with memory and processing functionality. The timing circuit 130 may embody a micro-power chip with an oscillator that counts time as a real-time clock. The chip may couple with its own power supply, often a lithium battery with extensive lifespan (e.g., >2 years). A counter may couple with the oscillator. The counter processes signals from the oscillator to output time increments, preferably at accuracy that comports with national standard clocks. Generally, memory 132 may embody memory devices that are volatile or non-volatile, as desired. Preference may be given to non-volatile devices for data that requires long-term retention, particularly during periods of pro-longed power outage or like disturbances. Executable instructions 134 may embody software, firmware, or like computer programs that configure functionality on the processor 128. This functionality may process data from the incoming data signal D₁ of the sensor unit 118 and from the timing circuit 130. These processes may generate data that defines flow parameters (e.g., flow and volume) for the resource 104 as it transits through the body 106. The processes may also transmit the data as the digital signal S₁, for example, to the indexing unit 112 for use with a display, or for broadcast to a meter reader device or onto a network that provides the utility with access to the gas meter 102. The utility may use the data to generate bills for customers or to perform diagnostics to check heath and other operating characteristics of the gas meter 102.

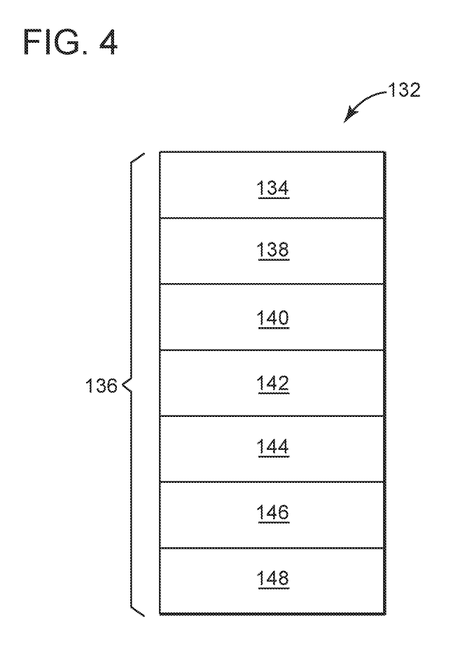

FIG. 4 depicts a schematic diagram of an example of memory 132 to illustrate different types of resident data 136 on the encoder device 100. This stored data may also include raw data 138 that corresponds with “counts,” for example, pulses the sensor unit 118 generates in response to each rotation of the impellers 112. This count data correlates well with volumetric flow of fuel gas 104, but is generally not “corrected” to account for certain environmental conditions at or near the gas meter 102. In one implementation, the power unit 120 may operate with each rotation of the impellers 112 so that the power signal S₁ is sufficient to operate computing components 128, 130 at least to write the uncorrected data 136 to the memory 130. This feature retains data in memory 132 that defines customer consumption independent of power available on the gas meter 102. Utilities may recover the uncorrected data 138 to calculate (or estimate) customer use that occurs during power outage or other issues that may frustrate operation of the gas meter 102 to properly generate and deliver data, e.g., via the digital signal S₁.

Other data found on memory 132 may also prove useful for operation of the gas meter 102. The data may embody correction data 140, for example, data that functionality of the processor 128 may use to compensate for low-flow conditions that occur across the metering unit 112. The data may include “logged” data that functionality of the processor 128 actively stores or reads to the memory 132. This logged data may embody measured data 142, typically data that defines values for temperature, pressure, or like variables. These values may originate from sensors on or in proximity to the gas meter 102. The logged data may also include calculated data 144, for example, data that defines values for flow parameters of fuel gas 104. These values may quantify flow, volume, and like parameters that are useful to generate accurate, reliable data that defines volumetric flow of fuel gas 104 to satisfy customer demand. In one implementation, functionality of the processor 128 may also create event data 146 that captures or defines operating conditions on the gas meter 102. For example, the event data 146 may identify issues or problems on the device, effective consumer demand, as well as replacement or maintenance that occurs on the device. Still other data may prove useful to identify the gas meter 102. This data may embody identifying data 148, often values that serve to distinguish the gas meter 102, or its hardware, from others. These values may include serial numbers, model numbers, or software and firmware versions. For security and integrity, the values may include cyclic redundancy check (CRC) numbers, check-sum values, hash-sum values, or the like. These values can deter tampering to ensure that the encoder device 100 or gas meter 102 will meet legal and regulatory requirements for purposes of metering fuel gas 104.

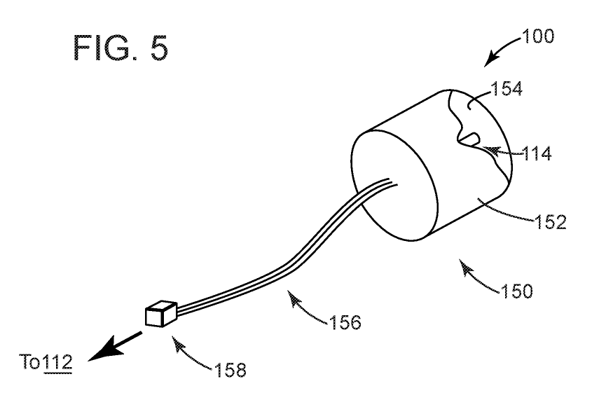

FIG. 5 depicts a schematic diagram of exemplary structure for the encoder device 100 of FIG. 1. The structure may include an enclosure 150 with a peripheral wall 152, for example, a thin-walled member made of plastic or composite material. This thin-walled member may form an interior cavity 154, preferably sealed to enclose the units 118, 120 inside of the enclosure. This construction may serve to protect the devices and provide adequate structure to secure the enclosure 150 to the gas meter 102. The data processing unit 114 may also reside in the cavity 154. It may benefit the design to include potting material as well to secure the data processing unit 114 and the units 118, 120 to the peripheral wall 152 or other structure in the cavity 154. A data connection 156 may connect with the data processing unit 114. The data connection 156 may embody a cable or wiring harness compatible with signals in digital or analog form, although preference may be given to construction that can transmit power as well. The cable 156 extends away from the thin-walled member to a connector 158. In one implementation, the connector 152 can interface with parts of the indexing unit 112, which can process data or communicate with remote devices.

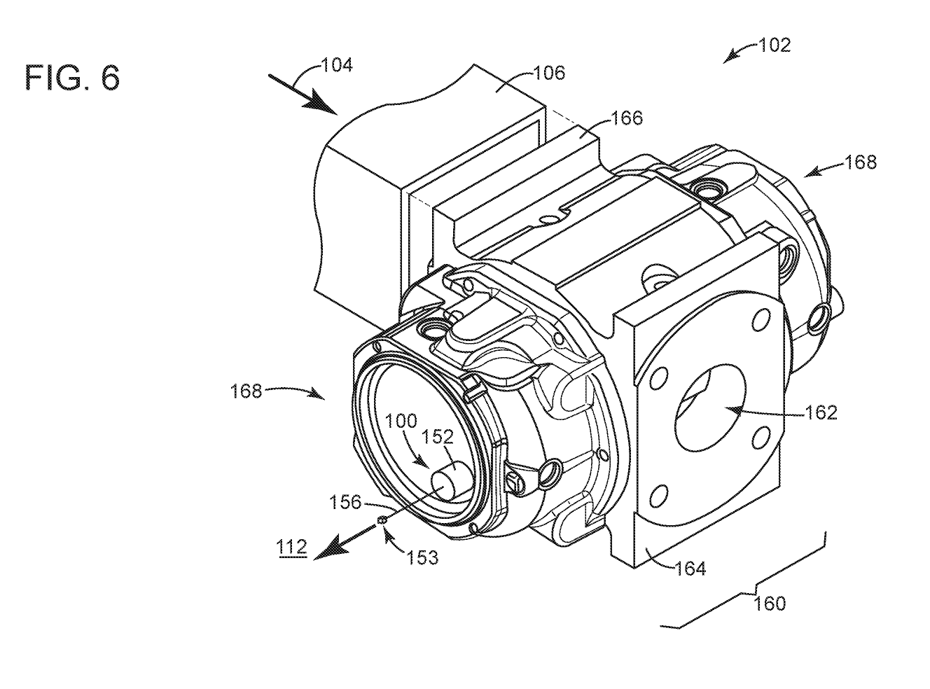

FIG. 6 depicts a perspective view of the encoder device 100 of FIG. 5 resident on an example of structure for the gas meter 102. This structure may include a meter body 160, typically of cast or machined metals. The meter body 160 may form an internal pathway that terminates at openings 162 with flanged ends (e.g., a first flanged end 164 and a second flanged end 166). The ends 164, 166 may couple with complimentary features on a pipe or pipeline to locate the meter body 160 in-line with the conduit 106. As also shown, the meter body 160 may have covers 168 disposed on opposing sides of the device. The enclosure 152 may mount to one of the covers 168 to communicate with the metering unit 114 found inside the meter body 156. Fasteners, like adhesives or potting materials, may provide secure attachment without interfering with operation of the units 118, 120.

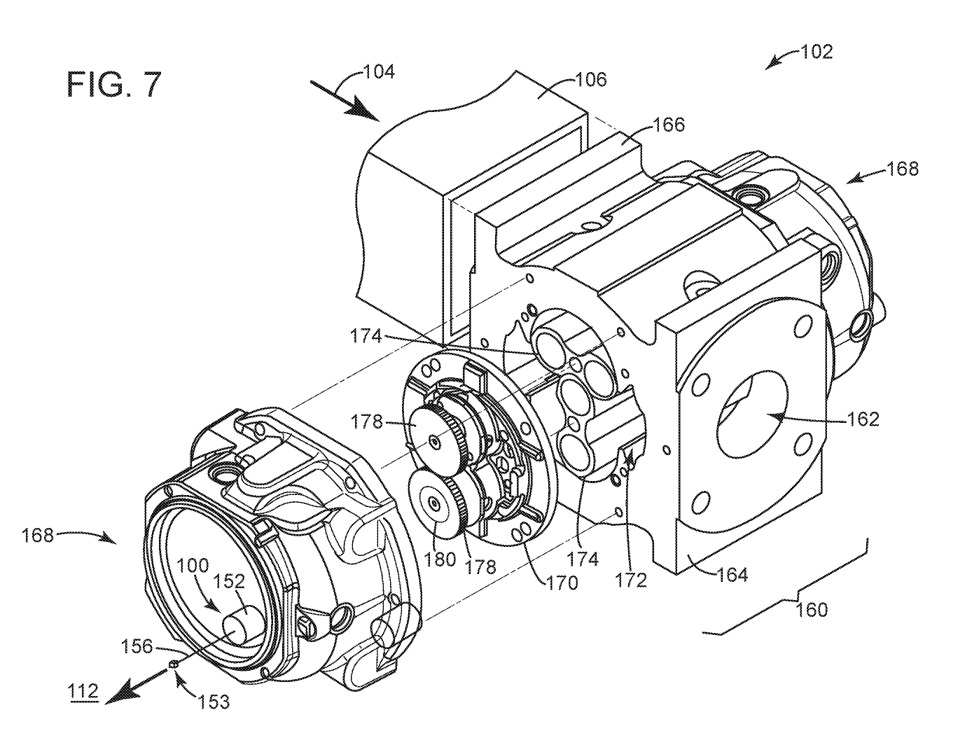

FIG. 7 shows the perspective view of FIG. 6 with the gas meter 102 in partially-exploded form. The meter device 112 may comprise a mechanical assembly, shown here having a cylinder cover plate 170 that secures to the meter body 160. The cover plate 170 encloses and seals an inner cavity 172 on the meter body 160. The interior cavity 172 houses a pair of impellers 174. The mechanical assembly may embody a gear assembly 176 having a pair of gears 178. The gears 178 may couple with the impellers 174, typically by way of one or more shafts that extend through the cover plate 168 to engage with the impellers 174. A magnetic device 180 may couple to one of the gears 178, shown here as an annular ring. But construction for the magnetic device 180 may vary as necessary to accommodate structural and design considerations. As noted above, the cover 168 may locate the encoder device 100 in proximity to the magnetic device 180 to stimulate response of the units 118, 120, as well as to provide access to the mechanical assembly. In one implementation, the impellers 174 counter-rotate in response to flow of fuel gas 104. This movement displaces a fixed volume of fuel gas 104 that transits the meter body 160 between flanged ends 164, 166. The rate at which the impellers 174 rotate relates to the rate at which fuel gas 104 flows through the meter body 160. For many applications, the rate of rotation of the impellers 174 is directly proportional to the flow rate of fuel gas 104 so that with each full revolution of the impellers 174 and, in turn, corresponding impeller shafts, a precise volume of fuel gas 104 moves through the meter body 160.

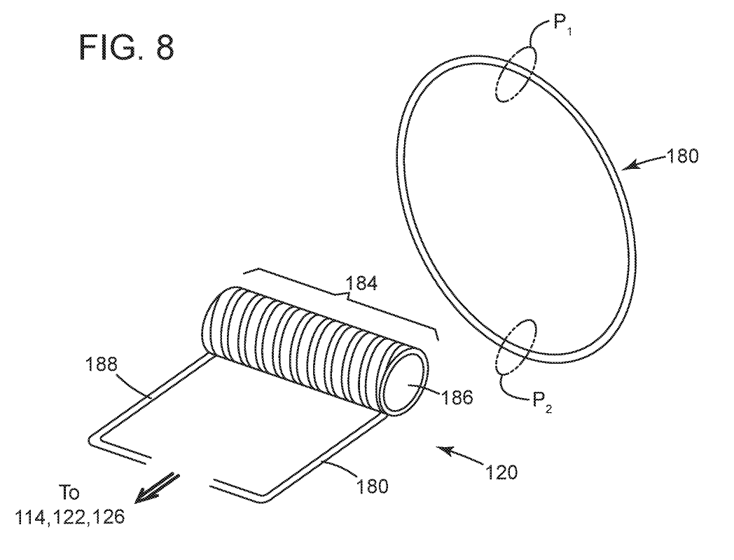

FIG. 8 depicts a perspective view of exemplary structure for the power unit 120 that can work in conjunction with the magnetic device 180 of FIG. 7. This structure may reside in the enclosure 150 along with the Wiegand sensor 118. In one implementation, the power unit 120 may embody a thin-diameter wire 182 forming windings 184 that circumscribe a core 186. The windings 184 may couple with leads 188. The leads 188 may extend to the processing unit 114, the power management unit 122, or the energy storage unit 126. As noted herein, the core 186 may comprise magnetic material, and be solid or hollow. The annular ring 180 have magnetic poles P₁, P₂ that are diametrically opposed from one another; but other construction may incorporate additional magnetic poles as well.

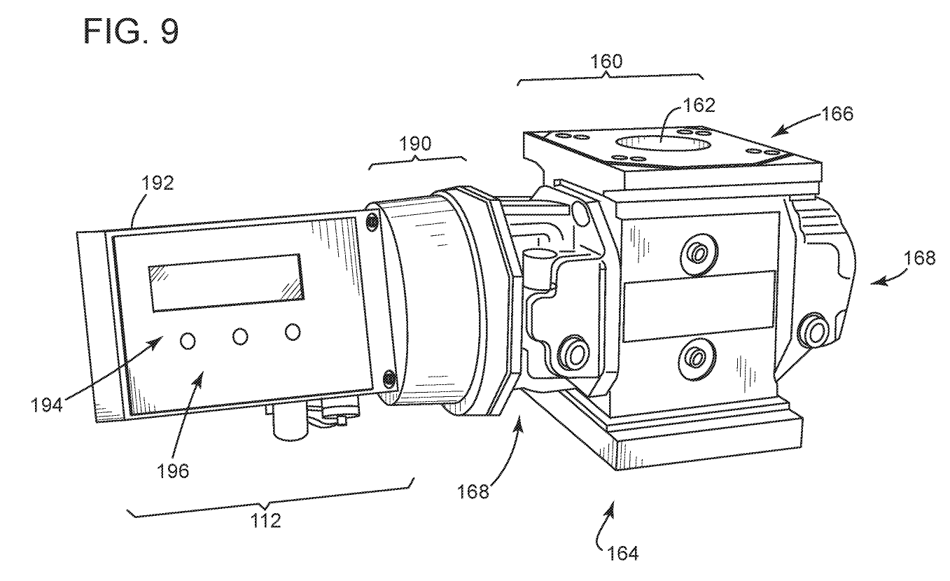

FIG. 9 depicts a perspective view of exemplary structure for the gas meter 102 of FIGS. 6 and 7. One of the covers 168 may feature a connection 190, possibly flanged or prepared to interface with the indexing unit 112, shown here with an index housing 192 having an end that couples with the connection 190. The index housing 192 may comprise plastics, operating generally as an enclosure to contain and protect electronics to generate data for volumetric flow of fuel gas through the meter body 160. The index housing 192 may support a display 194 and user actionable devices 196, for example, one or more depressable keys an end user uses to interface with interior electronics to change the display 194 or other operative features of the device.

In view of the foregoing, the improvements herein outfit flow devices, like gas meters, with hardware to capture and retain redundant data. This hardware uses operative movements on the gas meter to both harvest energy and generate data that relates to volume flow. The energy is useful to power computing components to store this data in memory, preferable non-volatile. This feature creates a retrievable store of raw volume (or flow) data. Utilities can access the raw data to re-create or corroborate customer consumption for periods of operation that occur during power “outage” or disruption on the gas meter. As a result, the utility can avoid potential issues with accuracy and reliability at time of billing customers.

Topology for circuitry herein may leverage various hardware or electronic components. This hardware may employ substrates, preferably one or more printed circuit boards (PCB) with interconnects of varying designs, although flexible printed circuit boards, flexible circuits, ceramic-based substrates, and silicon-based substrates may also suffice. A collection of discrete electrical components may be disposed on the substrate, effectively forming circuits or circuitry to process and generate signals and data. Examples of discrete electrical components include transistors, resistors, and capacitors, as well as more complex analog and digital processing components (e.g., processors, storage memory, converters, etc.). This disclosure does not, however, foreclose use of solid-state devices and semiconductor devices, as well as full-function chips or chip-on-chip, chip-on-board, system-on chip, and like designs. Examples of a processor include microprocessors and other logic devices such as field programmable gate arrays (“FPGAs”) and application specific integrated circuits (“ASICs”). Memory includes volatile and non-volatile memory and can store executable instructions in the form of and/or including software (or firmware) instructions and configuration settings. Although all of the discrete elements, circuits, and devices function individually in a manner that is generally understood by those artisans that have ordinary skill in the electrical arts, it is their combination and integration into functional electrical groups and circuits that generally provide for the concepts that are disclosed and described herein.

This written description uses examples to disclose the invention, including the best mode, and also to enable any person skilled in the art to practice the invention, including making and using any devices or systems and performing any incorporated methods. An element or function recited in the singular and proceeded with the word “a” or “an” should be understood as not excluding plural said elements or functions, unless such exclusion is explicitly recited. References to “one embodiment” of the claimed invention should not be interpreted as excluding the existence of additional embodiments that also incorporate the recited features. Furthermore, the claims are but some examples that define the patentable scope of the invention. This scope may include and contemplate other examples that occur to those skilled in the art. Such other examples are intended to be within the scope of the claims if they have structural elements that do not differ from the literal language of the claims, or if they include equivalent structural elements with insubstantial differences from the literal language of the claims.

Examples appear below that include certain elements or clauses one or more of which may be combined with other elements and clauses describe embodiments contemplated within the scope and spirit of this disclosure.

What is claimed is:

1. A gas meter, comprising:
a meter body with flanged ends, the meter body forming an interior cavity;
impellers disposed in the interior cavity; and
an encoder device coupled with the impellers, the encoder device comprising:
a processor and memory,
a sensor unit, and
a power unit,
the sensor unit and the power unit responsive to rotation of the impellers to generate a data signal and a power signal, respectively, without contact with the impellers.

2. The gas meter of claim 1, wherein the power signal energizes the processor.

3. The gas meter of claim 1, wherein the power signal energizes the processor, which responds by recording data in memory, the data corresponding with the data signal.

4. The gas meter of claim 1, further comprising:
energy storage on board the encoder device to provide power to the processor,
wherein the power unit couples with the energy storage.

5. The gas meter of claim 1, wherein the sensor unit comprises a Wiegand sensor.

6. The gas meter of claim 1, wherein the power unit comprises a thin wire conductor wrapped around a magnetic core.

7. The gas meter of claim 1, wherein the encoder device includes an enclosure that seals the sensor unit, the power unit, the processor, and memory inside and affixes to the meter body.

8. The gas meter of claim 7, wherein the encoder device includes a wiring harness that extends from the enclosure.

9. The gas meter of claim 1, further comprising:
executable instructions on the memory that configure the processor to,
process the signal from the sensor unit to generate a digital signal that corresponds with volumetric flow of a fluid

10. The gas meter of claim 1, further comprising:
executable instructions on the memory that configure the processor to,
store raw data on memory that correspond with the data signal from the sensor unit.

11. An encoder device, comprising:
a Wiegand sensor;
a thin wire conductor wrapped around a magnetic core;
a processing unit coupled with the Wiegand sensor to exchange signals, the processing unit comprising a processor coupled with memory having executable instructions stored thereon, the executable instructions configure the processor to,
receive a signal from the Wiegand sensor; and
store raw data in memory corresponding with the signal; and
an enclosure sealing the Wiegand sensor, the thin wire conductor, the magnetic core, and the processing unit in an interior cavity.

12. The encoder device of claim 11, wherein the executable instructions configure the processor to,
process the signal from the Wiegand sensor to generate a digital signal.

13. The encoder device of claim 11, wherein memory includes a cyclic redundancy check (CRC) number.

14. The encoder device of claim 11, further comprising:
a wiring harness that extends from the enclosure.

15. A method, comprising:
concomitantly generating a data signal and a power signal in response to rotation of impellers on a gas meter; and
recording data in memory that corresponds with the data signal.

16. The method of claim 15, further comprising:
directing the power signal to a processor.

17. The method of claim 15, further comprising:
directing the power signal to an energy source.

18. The method of claim 15, further comprising:
processing the data signal; and
generating a digital signal that correlates data from the data signal to volumetric flow of fluid.

19. The method of claim 15, further comprising:
stimulating a Weigand sensor,
wherein the data signal originates from the Weigand sensor.

20. The method of claim 15, further comprising:
stimulating a wire conductor wrapped around a magnetic core,
wherein the power signal originates from the wire conductor.
